(19) United States
(12) Patent Application Publication
(10) Pub. No.: US 2010/0097981 A1
(43) Pub. Date: Apr. 22, 2010

(54) METHODS AND SYSTEMS FOR PROVIDING MULTIPLE MEDIA STREAMS IN A HYBRID WIRELESS NETWORK

(76) Inventors: Nishi Kant, San Jose, CA (US); Heeseon Lim, Cupertino, CA (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 12/253,216

(22) Filed: Oct. 16, 2008

(51) Int. Cl. H04W 8/18; H04W 40/00

(52) U.S. Cl. 370/328; 455/432.3

(57) ABSTRACT

A hybrid cellular and IWLAN network having an access gateway providing a user with simultaneous access to GGSN base packet data services and PDG based broadband multi-media services with one IP address. The system further comprises an authentication center retrieving the user's subscription profile information from an operator network to check the user's subscription to simultaneous GGSN and PDG services, wherein said access gateway multiplexes and de-multiplexes the service sessions without any change to said user.

### CROSS-REFERENCE TO OTHER APPLICATIONS

Priority is claimed from U.S. provisional application 61/066,152, which is hereby incorporated by reference.

### FIELD OF THE INVENTION

The present application relates to the integration of different networks, such as cellular and non-cellular networks, and more particularly to the efficient delivery of multiple services over hybrid networks.

### BACKGROUND OF THE INVENTION

Note that the points discussed below may reflect the hindsight gained from the disclosed inventions, and are not necessarily admitted to be prior art.

### GPRS, 3G-UMTS and LTE Networks

GPRS (General Packet Radio Service) is an architecture that adds packet-switching capabilities over GSM networks to provide packet data services to mobile user equipment [UE]. GPRS networks support flexible data transmission rates as well as continuous connection to the network. GPRS can co-exist with circuit switched services and therefore can use existing GSM or 3G-UMTS physical nodes in the access network.

Additional nodes, such as GGSN (gateway GPRS support node) and SGSN (serving GPRS support node), are specified in the core network to support the GPRS packet data services functionality. SGSN provides the mobility and session management support (in other words, it is generally responsible for communication between the GPRS network and all the GPRS users located within its service area), while the GGSN provides connectivity between user and external data networks (such as the Internet or operator network) (i.e., it is the gateway to external networks).

The 3G-UMTS standards adopt the GPRS network functionality and network nodes (SGSN and GGSN) and enhance the capabilities in the network to deliver higher speed packet data services to the UE in the 3G-UMTS networks.

The Long-Term Evolution (LTE) 4G network specifications plan to extend the broadband access capabilities in the mobile-network to higher speeds as well as the transition of the mobile access network to an all Internet Protocol (IP) network.

The IP Multi-Media Subsystem (IMS) is a set of standards that extend the capabilities and services in a 3G-UMTS network to enable the delivery of rich-multi-media presence and instant messaging services.

### Hybrid Networks

As alternative access technologies (Wi-Fi, WiMAX etc.) have emerged, mobile operators have started using hybrid networks in addition to the traditional cellular network in order to deliver services. These alternative accesses are typically IP based and have a gateway to interface with rest of the mobile core network. For example, the IWLAN (Inerworking WLAN) standard uses TTG (Tunnel Termination Gateway) or PDG (Packet Data Gateway) for making operator GPRS/3G-UMTS/LTE packet data services available over Wi-Fi networks. While this disclosure uses the Wi-Fi and IWLAN to explain the problems, the solution provided by approach disclosed here is equally applicable to other accesses or interworking solutions.

The existing packet data services are provided through the GGSN (GPRS Gateway Support Node) in the traditional GSM/3G UMTS mobile network. The GGSN has all the information in routing the services to the appropriate packet data network. The GGSN is also responsible for creating the charging information.

The TTG mode gateway in the IWLAN network enables users of the IWLAN network to access the existing packet data services of the GSM/3G UMTS mobile network through the GGSN. In order to utilize the GGSN services, the IWLAN standard utilizes the GTP protocol to interface the TTG with GGSN. Thus, the GGSN can allocate an IP address to the user device (UE) over the traditional 2G/3G network and over the alternative Wi-Fi access network as well. TTG provides the secure tunnel for the user traffic over Wi-Fi while the GGSN routes the user traffic back and forth between the UE and rest of data network.

The IWLAN PDG mode gateway enables the IWLAN user to access external packet data network services. The PDG in this case allocates an IP address for the UE and routes the traffic between UE and the external packet data network similar to the GGSN.

The TTG and PDG functions may be extended to support the integration of the IWLAN services with LTE networks.

The IMS services in a 3G network can be directly accessed through the PDG or via the GGSN through the TTG mode.

### Services and Service Access

While operators want to enable delivery of the packet data services connected through GGSN to the UE on an IWLAN network they also want to configure new broadband multimedia services (VoIP, IPTV) etc, directly from the PDG.

Real time multimedia services such as VoIP, Video streaming etc. are expected to be prevalent on alternative access networks since their higher bandwidth allows delivery of rich services in a cost effective way. These multi-media services may have different requirements from data services. As an example, an important aspect of a voice service is to reduce the latency and maintain voice quality. If the VoIP based voice service had to be routed via the TTG and GGSN path, it would incur packet processing delays at these nodes and hence additional latency. On the other hand, if the VoIP based voice service is handled directly at the PDG, the voice packets are processed by only one node the PDG in the core network, reducing the network latency for the voice service.

Such a services distribution (i.e., packet data services on GGSN, new broad-band multi-media services on PDG) results in two service anchors. With two service anchors, there will be two IP addresses—one assigned by the GGSN for the packet data services and one assigned by PDG for the new broadband multi-media services. Moreover, as per the IWLAN standard, this would also result in two IPsec tunnels from the UE, one to the TTG and another to the PDG. However, handsets may not support multiple IP addresses, and even in the case where the handset does support multiple IP addresses, multiple IPsec tunnels are undesirable.

In summary, simultaneous voice and data service over alternative access networks can be provided today by:
Having the GGSN as the service anchor for both broadband multi-media and data services. However, this has the drawback of adding overhead for the broadband multi-media service packets.
Having the PDG as the service anchor for both broadband multi-media and data services. However, this has the drawback of having to move all existing services from the GGSN to the PDG.
Having the GGSN as the service anchor for the data services and PDG as the service anchor for the broadband multi-media services. However, this has the drawback of needing to support multiple IP addresses at the handset as well as added complexity at the time of handoff between the IWLAN access network and 2G/3G-UMTS access network.

### Services Authorization and Access Point Name (APN)

The HLR (Home Location Register) is the central database in GRPS/UMTS cellular networks that is responsible for authentication and authorization of all subscribers.

An augmented node called the HSS (Home Subscriber Server) is used in 3G-UMTS networks using an IP Multi-Media Subsystem (IMS) core and in the Long-Term Evolution (LTE) 4G networks to provide equivalent functionality.

An HLR/HSS contains subscriber profile information and uses this user-specific profile information to provide service level authorization for the specific user or set of users.

The 3GPP AAA (Authentication, Authorization and Accounting) server, such as the SCN-RAC, is located within the GPRS/3G/LTE network and retrieves authentication information from the HLR/HSS of the IWLAN subscribers home network, authenticates the subscriber based on the authentication information retrieved from the HLR/HSS and communicates the authorization information to the TTG/PDG IWLAN network elements.

The SCN-RAC has an interface to the HLR element in the mobile network to retrieve subscriber profile information. The interface between the SCN-RAC and the HLR (103 and 104 in FIG. 1) is Gr′. Gr′ is defined in 3GPP as the interface between HLR and AAA server and is a subset of Gr, an interface between HLR and SGSN.

The SCN-RAC has an interface to the HSS element in the mobile network to retrieve subscriber profile information. The interface between the SCN-RAC and the HSS is Wx and is defined in 3GPP as the interface between the HSS and the AAA server.

The SCN-RAC has an interface to the PDG element in the IWLAN network to provide the retrieved subscriber profile information for use during IWLAN connection setup. The interface between the SCN-RAC and the PDG is Wm and is defined in 3GPP as the interface between the PDG and the AAA server.

GPRS/3G-UMTS systems use APN (Access Point Name) mechanisms for service authorization. The APN identifies the packet data network and the services that a user is accessing. HLR/HSS stores the subscribed APNs for each user. An illustrative APN can be: voice.operator.com.

When a mobile phone sets up a data connection in the mobile network (eg:PDP—Packet Data Protocol context), a corresponding APN is selected for the service. The SGSN compares the requested APN with the subscribed APN and the selected APN is then used in a DNS (Domain Name Service) query to a private DNS network. This process (called APN resolution) finally gives the IP address of the GGSN which provides the service that corresponds to the APN. At this point a PDP context can be activated. A subscriber typically only has access to those GPRS/UMTS services that are identified in the subscriber profile with the corresponding APNs.

An IWLAN architecture and set of specifications have been defined by 3GPP. These interworking specifications augment the central subscriber database at the HLR (or HSS—Home Subscriber Service) with new fields for service authorization over IWLAN, i.e. W-APN (wireless APN) in a similar manner to APN for service authorization over GPRS. Additional W-APN is added for each service that is to be provided over WLAN. However, this means that the user subscription profile in HLR needs to have double the number of APNs if the user is to receive all the subscribed services over WLAN as well as over GERAN/UTRAN. In other words, user profile needs to add the corresponding W-APNs for all the existing APNs. Doubling the profile information is undesirable to the operators due to many operational impacts.

Kant in U.S. application Ser. No. 11/283,546 disclosed a global W-APN approach as an authorization mechanism to access the subscribed services over WLAN. For example, the GPRS subscriber's profile in an HLR is updated with a global W-APN to indicate that the subscriber is authorized for IWLAN access. The global WLAN APN is also configured on an authorization server for the IWLAN, which is usually an AAA server.

When a subscriber of the GPRS network attempts to access the operator network using the IWLAN access network, the authorization server can discriminate against those subscribers according to whether the global W-APN is stored in their subscriber profile at the HLR. Users whose subscriber profiles at the HLR include the global WLAN APN are authorized to access the IWLAN. Users whose subscriber profiles do not include the global W-APN are not authorized to access the WLAN.

Thus, the existing HLR and subscriber profiles are re-used, without significant modification, so as to provide IWLAN access authorization. In this case, a single global W-APN is used for all users who are authorized to access the WLAN. This allows authorization to be performed without reproducing the HLR subscriber profile database (or one of similar size) at a separate IWLAN authorization server.

Alternatively, for every service APN potentially stored in a subscriber profile of the HLR, a corresponding wireless APN is created. In this case, a user has the usual APN in their profile for each service to which they are subscribed, and an additional “service W-APN” indicating they are also allowed to access that service via a WLAN access network. This allows per-service authorization over the IWLAN rather than global authorization over the IWLAN. Thus, a given user can be authorized to access certain services via the usual access network (such as a GPRS access network) and/or via a IWLAN access network. Though this approach is more cumbersome because it requires a plurality of different service W-APNs (e.g., one for each service) rather than the single global WLAN APN of other embodiments, it does permit distinction between the different access networks used by a mobile terminal. This distinction can be advantageous, for example, if billing requirements differ among the access networks used.

### SUMMARY OF THE INVENTION

The present application discloses new approaches to provide a mechanism for simultaneous access to GGSN based packet data services and PDG based new broadband multi-media services with one IP address over a single IPsec tunnel between the UE and a combination gateway that implements TTG+PDG functions in one node: Metro-WSG (M-WSG) in an IWLAN network. The MWSG node also provides a mechanism to multiplex and de-multiplex the service sessions without any new additional functional requirements in the UE.

The M-WSG may also include a GTP based interface with the SGSN so that new services could be provided over GPRS/3G-UMTS/LTE access in addition to the IWLAN access.

Moreover, with single logical association between UE and M-WSG, the UE could move between the two access networks while maintaining seamless access to all services.

The disclosed innovations, in various embodiments, provide one or more of at least the following advantages:
Utilizing the same IWLAN mechanism for broadband multi-media as well as packet data services,
An efficient solution with less overhead than UMA or other solutions, and a solution that is better suited to support broadband services,
No additional functional requirements to modify user equipment or core network equipment to add broadband multi-media service support.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1 schematically shows a preferred embodiment to support the GGSN-based packet data services and the PDG-based broadband multi-media voice services simultaneously.

### DETAILED DESCRIPTION OF SAMPLE EMBODIMENTS

The numerous innovative teachings of the present application will be described with particular reference to presently preferred embodiments (by way of example, and not of limitation).

Currently, the packet data service over 2G/3G networks is identified by the APN and the service over IWLAN access network is identified by W-APN.

Kant in an U.S. application Ser. No. 11/283,546 disclosed a global W-APN mechanism to signify the user's subscription to IWLAN and authorize the user to access all the subscribed services over WLAN.

The approach disclosed here makes use of the global W-APN concept and the combination gateway (Metro-WSG)'s capability to identify and separate the GGSN-based and PDG-based service flow and to maintain the same UE IP address for both flows.

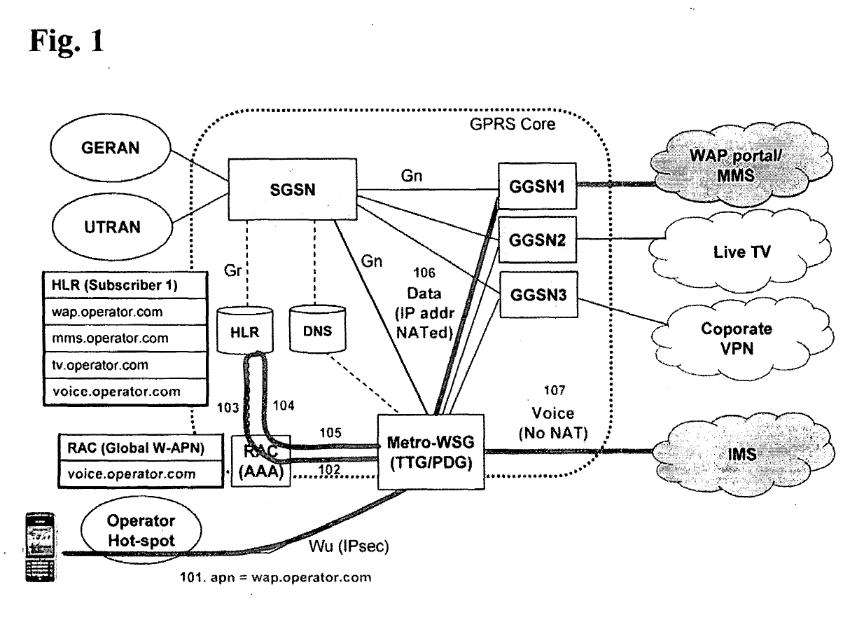

FIG. 1 shows a preferred embodiment to support the GGSN-based packet data services and the PDG-based broadband multi-media voice services simultaneously.

If the user subscribes to this simultaneous voice/data service, the user's subscription profile in the HLR is updated to include this information in the format of an APN. In this example, the APN voice.operator.com is added to the profile. The AAA server (SCN-RAC) is also updated with this global voice W-APN.

While FIG. 1 shows Network Address Translation (NAT) towards the GGSN, the innovation is equally applicable to the reverse case where traffic towards GGSN is not NAT'ed.

When the user is in the IWLAN and wants to access the GGSN-based data service, e.g. WAP portal, it sends the request with the appropriate APN (for example, wap.operator.com) to the Metro-WSG (101 in FIG. 1), an access gateway for IWLAN access networks. In this example the APN wap.operator.com indicates that the user wants to access the WAP portal.

Then the Metro-WSG sends access request message to the AAA server (SCN-RAC) with the requested APN wap.operator.com (102), which leads the SCN-RAC to request the subscription profile of the user from the HLR (103). The HLR returns the user subscription profile to the SCN-RAC (104), which includes the subscribed APN information. Due to the presence of the voice APN (i.e. voice.operator.com) in the user profile in addition to the packet data service APN wap.operator.com, SCN-RAC knows that this user may request the voice over IWLAN service at any time. SCN-RAC returns this information to the Metro-WSG (105) and Metro-WSG prepares for the initiation of the voice service session that user may initiate later.

The Metro-WSG assigns an IP address to the user session. Meanwhile since the service anchor for the data service is GGSN, M-WSG performs the TTG function and provides connectivity to the GGSN. M-WSG TTG sends ‘create PDP context’ request to GGSN, and GGSN responds with the IP address it assigned which the M-WSG uses to relay the data traffic to the GGSN (106).

Metro-WSG performs the NAT between the Metro-WSG assigned IP address and GGSN-assigned address. The GGSN-assigned IP address is used for any services that are serviced from the GGSN (for example operator services, like portal, WAP browsing or MMS).

When the user initiates the voice session later, the Metro-WSG identifies the voice traffic (i.e. SIP and/or RTP packets) by its packet inspection capability, and sends these packets directly to the IMS network (107). In this case, the IP address does not need to be replaced, and the Metro-WSG assigned IP address is used as the user IP address for voice communication. Further, the Metro-WSG assigned IP address is also used in any other services that are serviced directly from Metro-WSG through the PDG function.

When the user moves into a macro area, the traffic is coming from the SGSN to the Metro-WSG, and the Metro-WSG still maintains the data and the voice session. Therefore, both voice and data sessions are moved smoothly from WLAN to macro access network. Here the same data handover procedure by a proxy GSN architecture described by Kant in an U.S. application Ser. No. 11/234,072 is used to handover from WLAN area to 2G/3G area.

According to various embodiments, there is provided:

### MODIFICATIONS AND VARIATIONS OF THE INVENTION

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

None of the description in the present application should be read as implying that any particular element, step, or function is an essential element that must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and no subject matter is intentionally relinquished, dedicated, or abandoned.

What is claimed is:

1. A hybrid cellular and IWLAN network, comprising:
an access gateway providing a user with simultaneous access to GGSN based packet data services and PDG based broadband multi-media services with one IP address; and
an authentication center retrieving said user's subscription profile information from an operator network to check a user's subscription to simultaneous GGSN and PDG services; and
wherein said access gateway multiplexes and de-multiplexes the service sessions without any change to said user.

2. The network of claim 1, wherein said access gateway is a node implementing both TTG and PDG functions.

3. The network of claim 1, wherein said user roams between a cellular network and a WLAN network seamlessly through said gateway.

4. The network of claim 1, wherein said user profile information contains a special APN that identifies the user's subscription to simultaneous GGSN and PDG based services.

5. The network of claim 1, wherein said access gateway performs the IP replacement action between GGSN-assigned IP address and Gateway-assigned IP address for the packet data packets that are routed to said GGSN.

6. The network of claim 1, wherein said access gateway has the capability to distinguish between packet data service packets and broadband multi-media service packets and treat them differently according to pre-defined rules.

7. The network of claim 1, wherein said gateway forwards the broadband multi-media packets directly to an external network, including an IMS network, using an IP address assigned by the gateway without an IP address replacement.

8. A method for supporting multiple services using one IP address in a hybrid cellular and IWLAN network, comprising the actions of:
when a dual-mode mobile client initiates a service request, retrieving said client's subscription profile to obtain all the services authorized for the subscriber and sending this information to an access gateway;
when said client sends said access gateway packet data traffic, routing said client's packet data traffic via GGSN; and
when said client sends said gateway non-packet data broadband multi-media traffic, routing said client's non-data traffic directly at the access gateway without involving a GGSN.

9. The method of claim 8, wherein said access gateway performs network address translation between GGSN-assigned IP address and gateway-assigned IP address for said packet data traffic, while no address translation is performed for non-packet data broadband multi-media traffic.

10. The method of claim 8, wherein said information is represented by a special APN that identifies the user's subscription to simultaneous GGSN and PDG based services.

11. The method of claim 8, wherein said subscriber profile information is stored in an HLR or an HSS.

12. The method of claim 8, wherein said multi-media traffic comprises a voice service.

13. The method of claim 8, wherein said multi-media traffic comprises a video service.

14. The method of claim 8, wherein said multi-media traffic comprises a multi-media service.

15. The method of claim 8, wherein said gateway inspects an IP packet to identify a packet data packet from a broadband multi-media non-data packet.

16. The method of claim 15, wherein said gateway inspects the IP packet and identifies a multi-media non-data packet by identifying RTP or SIP protocol packets used for session establishment and data transport respectively.
